(19) United States
(12) Patent Application Publication
(10) Pub. No.: US 2025/0170698 A1
(43) Pub. Date: May 29, 2025

(54) HAND TOOLS AND METHOD OF FABRICATION THEREOF

(71) Applicant: GARANT GP, Saint-François-de-la-Rivière-du-Sud (CA)

(72) Inventor: Anthony LAMONDE, Levis (CA)

(21) Appl. No.: 18/935,812

(22) Filed: Nov. 4, 2024

Related U.S. Application Data
(60) Provisional application No. 63/602,415, filed on Nov. 23, 2023.

(51) Int. Cl. B25G 3/20; A01D 9/02; B25G 3/26

(52) U.S. Cl. CPC B25G 3/20; A01D 9/02; B25G 3/26

(57) ABSTRACT

An attachment system and method allows reversely operating a working head with a shaft of different lengths selectively. A first hand tool is reversely connected to an extension shaft to obtain a second, longer-shafted hand tool, both fully operational and sturdy for hand-use, according to applications, work conditions and ergonomics. A range of different lengths hand tools may be contemplated, such as shovels, forks, trowels, transplanters, weed cutters, rakes, hoes, planters, and scoops, for example.

### CROSS REFERENCE TO RELATED APPLICATIONS

This application claims benefit of U.S. provisional application Ser. No. 63/602,415, filed on Nov. 23, 2023. All documents above are incorporated herein in their entirety by reference.

### FIELD OF THE INVENTION

The present invention relates to hand tools. More specifically, the present invention is concerned with hand tools and a method of fabrication thereof.

### BACKGROUND OF THE INVENTION

Hand tools are available in a range of handle or shaft lengths. Short-handled tools allow a user to operate the working tool head from a short distance, while longer-shafted hand tools are useful to manipulate the working tool head from a distance. A given working tool head may be efficiently operated either with a short or long shaft depending on the work at stake.

Typically, tool heads are configured for connection to shafts and cannot be used on their own.

There is still a need in the art for hand tools.

### SUMMARY OF THE INVENTION

More specifically, in accordance with the present invention, there is provided a tool, comprising a tool shaft, a tool head, a sleeve removably connecting the tool head to the tool shaft, and a clamp connected to the sleeve between an open position and a closed position; and, i) in the closed position, the clamp locks the sleeve about the tool head, thereby connecting and locking the tool head to the tool shaft; and ii) in the open position, the sleeve is unlocked, thereby unlocking the tool head from the tool shaft.

There is further provided a combination comprising a first shaft of a first length, a first tool, comprising a second shaft of a second length, a sleeve, and a clamp connected to the sleeve between an open position and a closed position; and i) in the closed position, the first shaft and the second shaft are aligned, and the clamp locks the sleeve about the first shaft and the second shaft, thereby connecting and locking the first shaft and the second shaft together, and the first tool to the first shaft into a second tool comprising a third shaft; and ii) in the open position, the sleeve is unlocked thereby unlocking the first tool from the first shaft.

There is further provided an extension shaft for a tool, comprising a sleeve and a clamp connected to the sleeve between an open position and a closed position, with the sleeve comprises an opening, and, i) in the open position of the clamp, the sleeve in configured to receive a free end of the tool; and ii) in the closed position of the clamp, the clamp locks the sleeve about the free end of the tool, thereby connecting and locking the tool to the extension shaft.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a perspective view of a hand tool according to an embodiment of an aspect of the present disclosure;

FIG. 2A shows details of FIG. 1 according to an embodiment of an aspect of the present disclosure;

FIG. 2B is a top view of FIG. 2A;

FIG. 3 is an exploded view of FIG. 2A according to an embodiment of an aspect of the present disclosure;

FIG. 4 shows details of FIG. 3;

FIG. 5A is a section view of a hand tool in closed position of the clamp according to an embodiment of an aspect of the present disclosure;

FIG. 5B is a section view of a hand tool in an open position of the clamp according to an embodiment of an aspect of the present disclosure;

FIG. 6A shows a hand tool according to an embodiment of an aspect of the present disclosure;

FIG. 6B shows details of the hand tool of FIG. 6A according to an embodiment of an aspect of the present disclosure; and

FIG. 6C shows details of the hand tool of FIG. 6A according to an embodiment of an aspect of the present disclosure.

### DESCRIPTION OF ILLUSTRATIVE EMBODIMENTS

The present invention is illustrated in further detail by the following non-limiting examples.

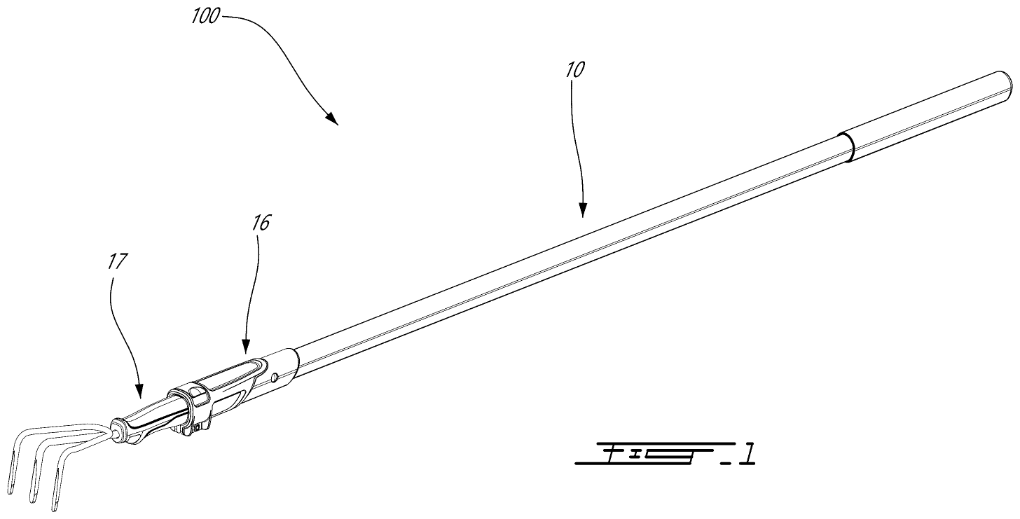

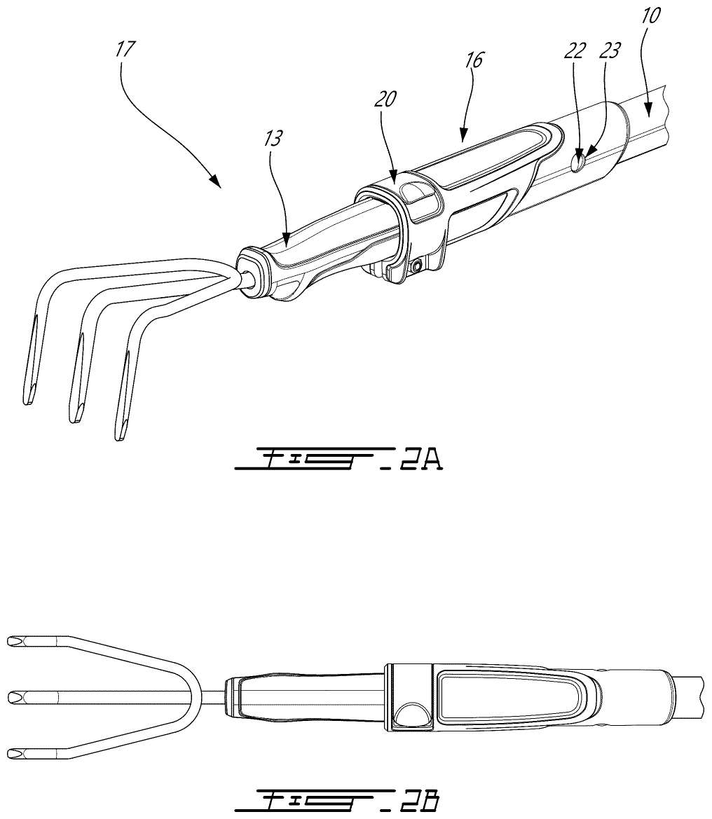

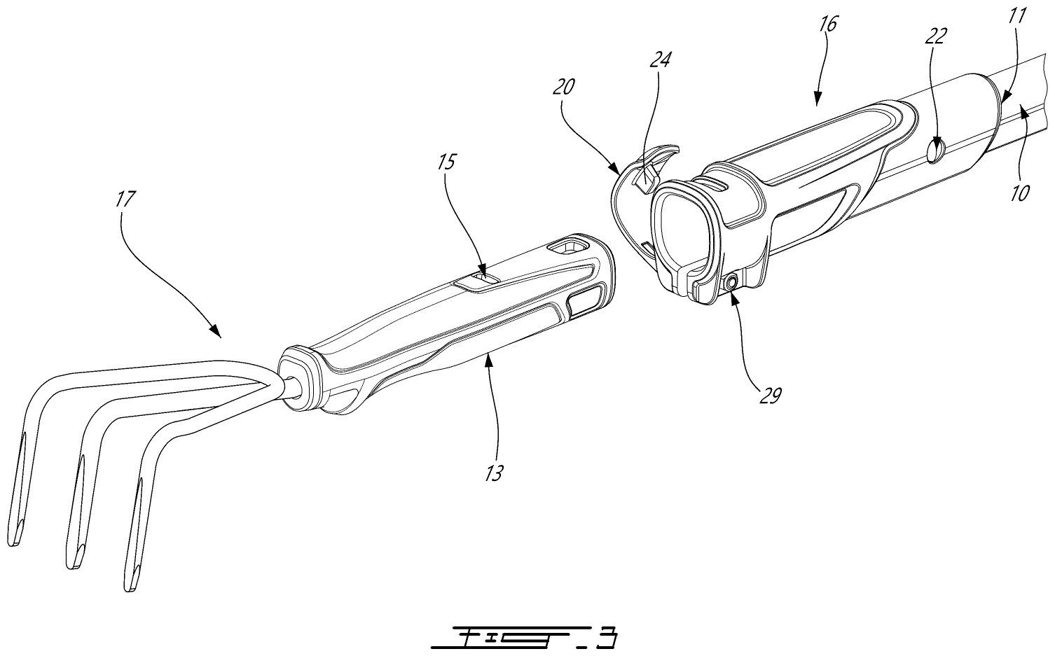

A first hand tool 100 comprising a hand tool shaft 10 and a hand tool head 17 according to an embodiment of an aspect of the present disclosure is shown in FIGS. 1 and 2 for example, with comprises a hand tool shaft 10 and a hand tool head 17.

The hand tool 100 is shown as a hand cultivator with a three prongs hand tool head 17 for illustration purposes only. Other hand tools may be contemplated, such as shovel head, a fork head, a trowel head, a transplanter head, a weed cutter, a rake head, a hoe head, a planter head, or a scoop, for example.

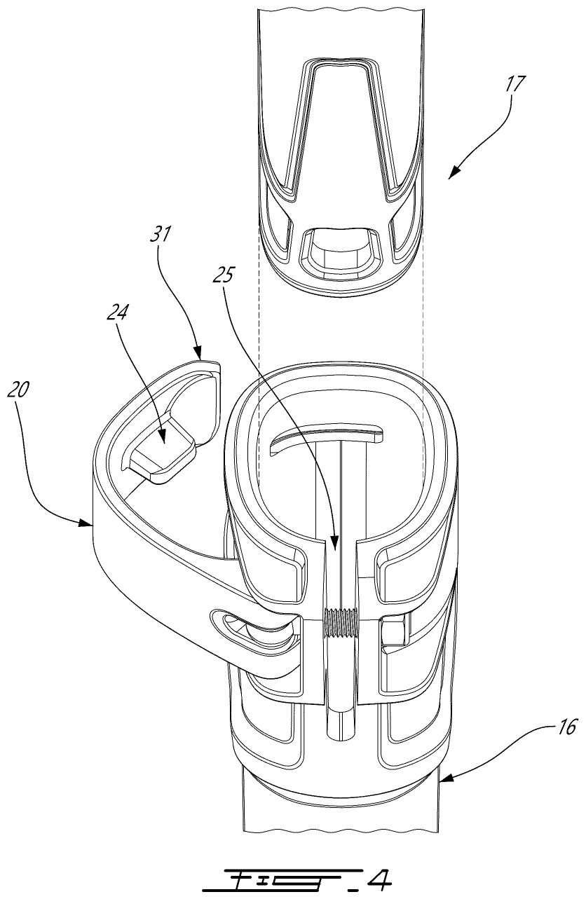

The hand tool head 17 is removably connected to a shaft connection end 11 of the hand tool shaft 10 by a sleeve, such as the slotted sleeve 16 (FIG. 3).

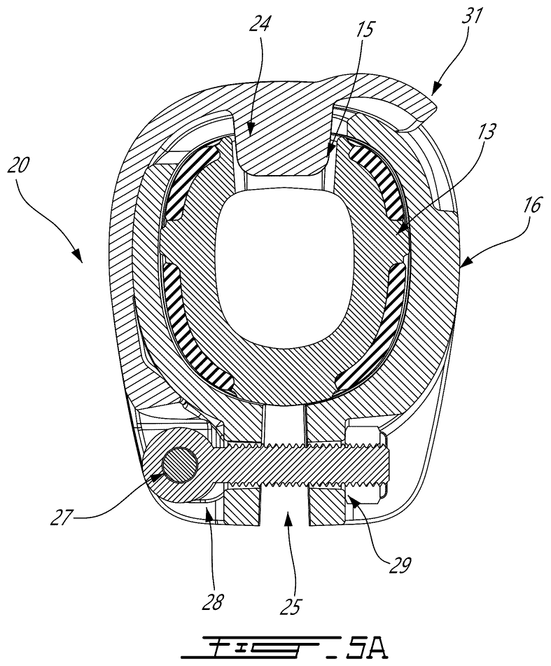

A clamp 20, such as an excentric C-clamp clamp 20, is rotatively connected to the sleeve 16 between an open position shown in FIGS. 3, 4 and 5B for example, and a closed position shown in FIGS. 1, 2, 5A for example, about a pin 27 housed in a rod end screw 28.

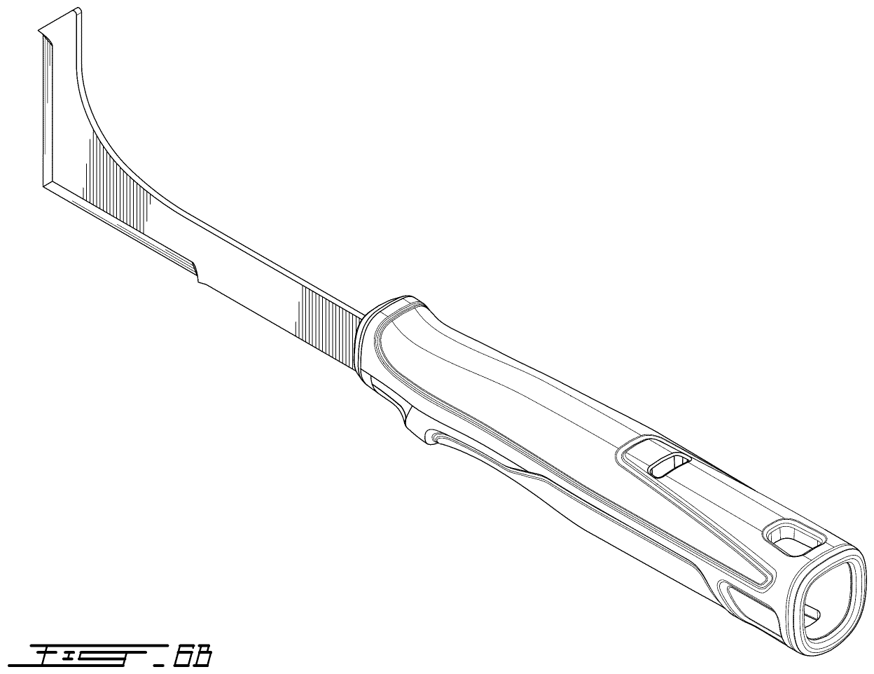

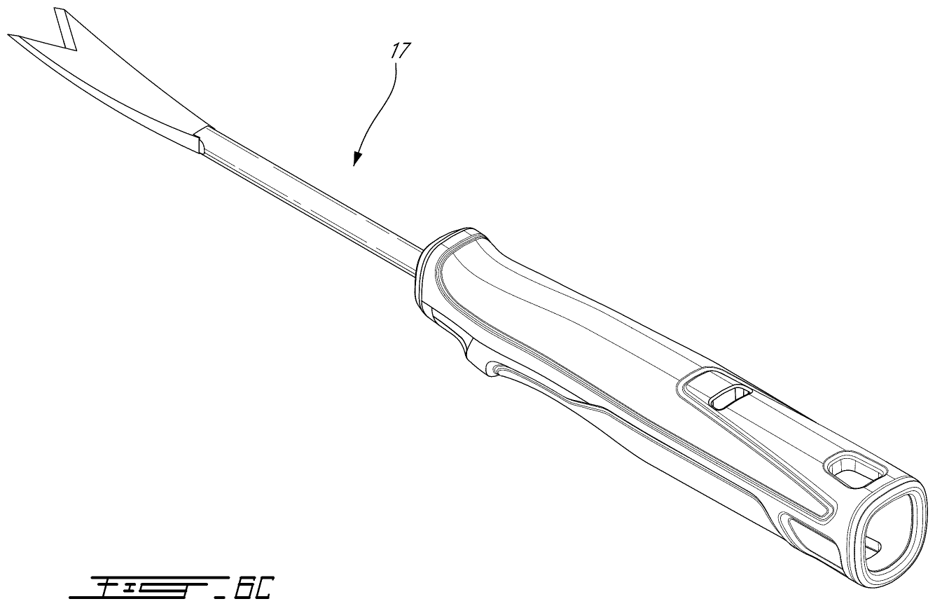

In the closed position (FIGS. 1, 2, 5A), the axial interference between the clamp 20 and the sleeve 16 and tightening the sleeve 16 about the hand tool head 17 is controlled by engaging a nut 29 of the rod end screw 28 to varying the width of the slot 25 in the sleeve 16; a locking tab 24 of the clamp 20 clipping into an opening 15 (see FIGS. 6A) of the proximal end 13 of the hand tool head 17 mechanically locks the sleeve 16 around the hand tool head 17 in addition to the tightening of the rotated clamp 20 around the sleeve 16 and locks lateral and axial movements between the sleeve 16 and the hand tool head 17.

Axial movement between the sleeve 16 and the hand tool shaft 10 may be controlled using a male/female lock, such as a rivet 22 in the connection end 11 of the hand tool shaft 10 that engages with an opening 23 through the sleeve 16 and the hand tool shaft 10 (FIG. 2A).

When the locking tab 24 clips within the sleeve 16 in the locked position, a click noise may confirm locking with between the hand tool head 17 and the hand tool shaft 10.

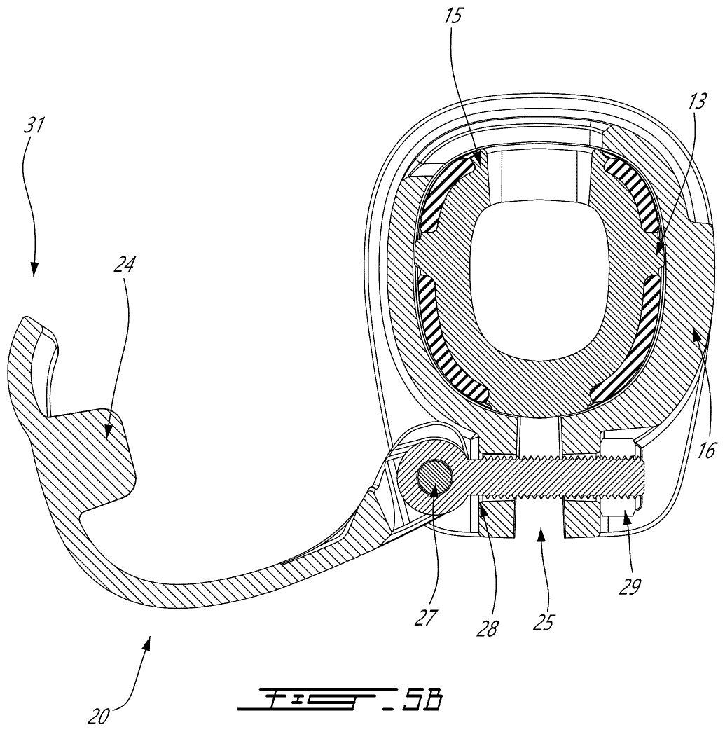

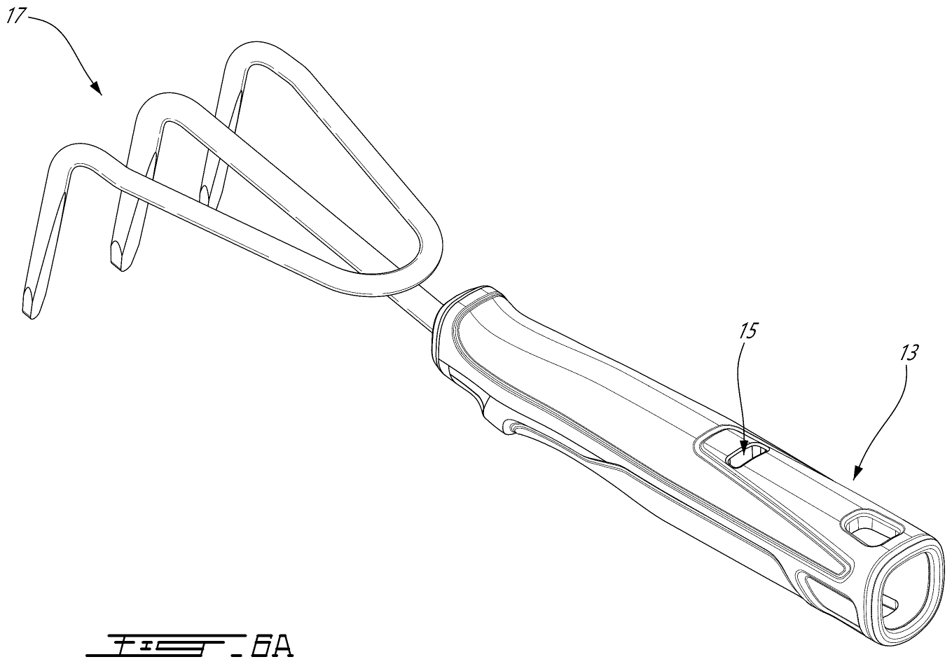

The hand tool 10 may be disassembled as follows: lifting a free end 31 of the clamp 20 disengages the locking tab 24 of the clamp 20 from the opening 15 of the hand tool head 17 so as to rotate the clamp 20 to the open position shown for example in FIG. 5B.

Thus, detached and separated from the hand tool shaft 10, the hand tool head 17 is a second hand tool of its own, as a shorter-shafted alternative to the hand tool 100, as shown in FIGS. 6, with the proximal end 13 as its handle. Reversely, it may be extended into the longer-shafted hand tool 10, as described hereinabove.

There is thus presented an attachment system and method that allows reversely operating a working head with a shaft of different lengths selectively. A first hand tool is reversely connected to an extension shaft to obtain a second, longer-shafted hand tool, both fully operational and sturdy for hand-use, according to applications, work conditions and ergonomics.

A range of different lengths hand tools may be contemplated, such as shovels, forks, trowels, transplanters, weed cutters, rakes, hoes, planters, and scoops, for example.

The scope of the claims should not be limited by the embodiments set forth in the examples, but should be given the broadest interpretation consistent with the description as a whole.

1. A tool, comprising:
a tool shaft;
a tool head;
a sleeve removably connecting the tool head to the tool shaft; and
a clamp connected to the sleeve between an open position and a closed position;
wherein:
i) in the closed position, the clamp locks the sleeve about the tool head, thereby connecting and locking the tool head to the tool shaft; and
ii) in the open position, the sleeve is unlocked, thereby unlocking the tool head from the tool shaft.

2. The tool of claim 1, wherein the clamp is an excentric clamp.

3. The tool of claim 1, wherein the clamp is rotatively connected to the sleeve.

4. The tool of claim 1, wherein the clamp comprises a locking tab, and, in the closed position of the clamp, the locking tab engages the tool head.

5. The tool of claim 1, wherein the tool shaft comprises a locking pin, the sleeve comprises an opening, and, in the closed position of the clamp, the locking pin engages the opening.

6. The tool of claim 1, wherein, from the closed position of the clamp, the clamp rotates out of abutment with the tool head.

7. The tool of claim 1, wherein, from the closed position, the clamp rotates out of abutment with the tool head thereby unlocking from around the sleeve and unlocking the tool head from the sleeve.

8. The tool of claim 1, wherein, from the closed position, the clamp rotates out of abutment with the tool head thereby unlocking from around the sleeve and unlocking the tool head from the tool shaft.

9. The tool of claim 1, wherein, from the closed position, the clamp rotates out of abutment from the tool head thereby untightening from around the sleeve and unlocking the sleeve from the tool head, thereby unlocking the tool head from the tool shaft.

10. A combination, comprising:
a first shaft of a first length;
a first tool, comprising a second shaft of a second length;
a sleeve; and
a clamp connected to the sleeve between an open position and a closed position;
wherein:
i) in the closed position, the first shaft and the second shaft are aligned, and the clamp locks the sleeve about the first shaft and the second shaft, thereby connecting and locking the first shaft and the second shaft together, and the first tool to the first shaft into a second tool comprising a third shaft; and
ii) in the open position, the sleeve is unlocked thereby unlocking the first tool from the first shaft.

11. The combination of claim 10, wherein the clamp is rotatively connected to the sleeve.

12. The combination of claim 10, wherein the clamp comprises a locking tab, and, in the closed position of the clamp, the locking tab engages the tool head.

13. The combination of claim 10, wherein the first shaft comprises a locking pin, the sleeve comprises an opening, and, in the closed position of the clamp, the locking pin engages the opening.

14. The combination of claim 10, wherein, from the closed position of the clamp, the clamp rotates out of abutment with the first tool.

15. The combination of claim 10, wherein, from the closed position, the clamp rotates out of abutment with the first tool thereby unlocking from around the sleeve and unlocking the first tool from the sleeve.

16. The combination of claim 10, wherein, from the closed position, the clamp rotates out of abutment with the first tool thereby unlocking from around the sleeve and unlocking the first tool from the first shaft.

17. The combination of claim 10, wherein, from the closed position, the clamp rotates out of abutment from the first tool thereby untightening from around the sleeve and unlocking the sleeve from the first tool, thereby unlocking the first tool from the first shaft.

18. The combination of claim 10, wherein the clamp is an excentric clamp.

19. An extension shaft for a tool, comprising a sleeve and a clamp connected to the sleeve between an open position and a closed position, wherein the sleeve comprises an opening, and,
i) in the open position of the clamp, the sleeve in configured to receive a free end of the tool; and
ii) in the closed position of the clamp, the clamp locks the sleeve about the free end of the tool, thereby connecting and locking the tool to the extension shaft.

20. An extension shaft for a tool according to claim 19, comprising a locking pin, a sleeve and a clamp connected to the sleeve between an open position and a closed position, wherein the sleeve comprises an opening, and,
i) in the open position of the clamp, the sleeve in configured to receive a free end of the tool; and
ii) in the closed position of the clamp, the clamp locks the sleeve about the free end of the tool and the locking pin engages the opening, thereby connecting and locking the tool to the extension shaft.
